(19) United States
(12) Patent Application Publication
(10) Pub. No.: US 2014/0229962 A1
(43) Pub. Date: Aug. 14, 2014

(54) Television Viewers Interaction and Voting Method

(71) Applicant: Michael Findlay, Flushing, NY (US)

(72) Inventor: Michael Findlay, Flushing, NY (US)

(21) Appl. No.: 14/185,924

(22) Filed: Feb. 21, 2014

Related U.S. Application Data
(63) Continuation of application No. 11/636,148, filed on Dec. 7, 2006, now abandoned.
(60) Provisional application No. 60/749,328, filed on Dec. 9, 2005.

(51) Int. Cl. H04N 21/475; H04N 21/258; H04N 21/235; H04N 21/442

(52) U.S. Cl. CPC H04N 21/4758; H04N 21/44222; H04N 21/25875; H04N 21/2353
USPC 725/13

(57) ABSTRACT

A method of providing audience feedback for a program includes a communication forming tag patterns embedded in an audio or video format. The communication is formed by software on a viewer device that encodes a message signal. When a link to the program is activated by the software viewers may send messages by embedding into the program. The messages any take the form of audio, video or text, and can be viewed using the same software on devices of other users. The software may be an app, embedded in a web site, or may be incorporated into a stand-alone box or in a computer chip to be place in any device to perform the same task. A person controlling the program may employ a camera overlay program box and re-air the communications of viewers while the program is aired and placed these comments directly on-screen.

### CROSS REFERENCE TO RELATED APPLICATIONS

This application is a continuation-in-part of U.S. patent application Ser. No. 11/636,148, filed Dec. 7, 2006.

### BACKGROUND

The present invention relates in general to methods for displaying messages on television (TV) programs, and more particularly to a TV viewer interaction and voting method via the Internet and telephone.

Television programs encouraging viewer interaction are known. Many programs involving competitions require viewer votes to determine a winner. Using currently available methods, viewers use a smart phone, access a website, or dial a telephone number and input data using the telephone keypad to vote for a favorite contestant or provide other selective data, and several methods and systems facilitating such an interaction and participation by viewers are known in the art.

U.S. 2005/0289622 to Vanlerberghe discloses a method for creating original, interactive television programming. A Short Messaging System (SMS) gateway is used to route text messages from a user's wireless device through a wireless carrier to a server. The SMS data is then converted to a graphical format, which can be added to a broadcast television signal for display on a television program.

U.S. 2004/0010797 to Vogel discloses a TV audience interaction method for inserting feedback from members of the viewing public into a television program. Viewers submit reactions to programming in real time in the form of spoken or text messages. The messages are received via telephone, SMS or Internet and later incorporated into the program being watched or into a separate program broadcast subsequently. Messages received in audio format can be converted in to text messages for display on the program and vice versa.

U.S. Pat. No. 6,584,613 to Dunn discloses a simplified TV viewer response system coupled to a telephone system that enables a viewer to respond to television displays by dialing a special code less than six digits. The code is routed to an enhanced services server, which captures the dial string including the caller, checks the caller against a viewer profile and maps the caller to the cable company providing service to the viewer. The server delivers the response to the cable television company which processes the response according to the selected items or choices in the TV screen. Several special dialing codes of limited digits expedite viewer selections.

Although the above systems and methods facilitate viewer interaction, creating personalized messages requires a viewer to type or speak over the phone. Since there is no limit to the content and size of messages, entering them can be time consuming and awkward.

It is therefore an object of the present invention to provide a TV audience interaction method that is more efficient and user friendly for creating personalized messages.

A further object is to provide a TV audience interaction method that provides user interfaces accessible over the Internet for creating personalized messages.

A further object is to provide a TV audience interaction method that uses dialing codes for creating personalized messages.

Finally, it is an object of the present invention to provide a TV audience interaction method that can be used for voting based on personalized messages. These and other objects of the present invention will become better understood with reference to the following summary, description, and claims.

### SUMMARY

A method for television (“TV”) viewer interaction and voting via the Internet and telephone is disclosed. The method facilitates creating messages for interaction with a TV program. In one preferred embodiment, viewers are provided with a plurality of preset words and characters to select from in order to form a message.

For creating messages over the Internet, a hosting website is provided for the viewers to select a TV program and the preset words and characters on a plurality of user interfaces. Preferably, the preset words are selected from a plurality of drop down dialog boxes. For creating messages over the telephone, each preset word and character is assigned a dialog code and a viewer is guided through a plurality of voice prompts to select a TV program and form a message.

The present invention can also be used for voting in a live TV program. Each possible message is assigned specific number of points. A viewer can choose a contestant and form a message about the performance of the contestant. The points of the message sent by the viewers will be added to determine the total number of votes for the contestant.

### BRIEF DESCRIPTION OF THE FIGURES

FIG. 1 is a flowchart of the TV viewers' interaction method via Internet in accordance with the present invention.

FIG. 2 is a flowchart of the TV viewers' interaction method via telephone in accordance with the present invention.

FIG. 3 is a flowchart of the TV viewers' voting method in accordance with the present invention.

FIG. 4 is a first alternative embodiment flowchart of the TV viewers' voting method in accordance with the present invention.

FIG. 5 is a second alternative embodiment flowchart of the TV viewers' voting method in accordance with the present invention.

### DESCRIPTION

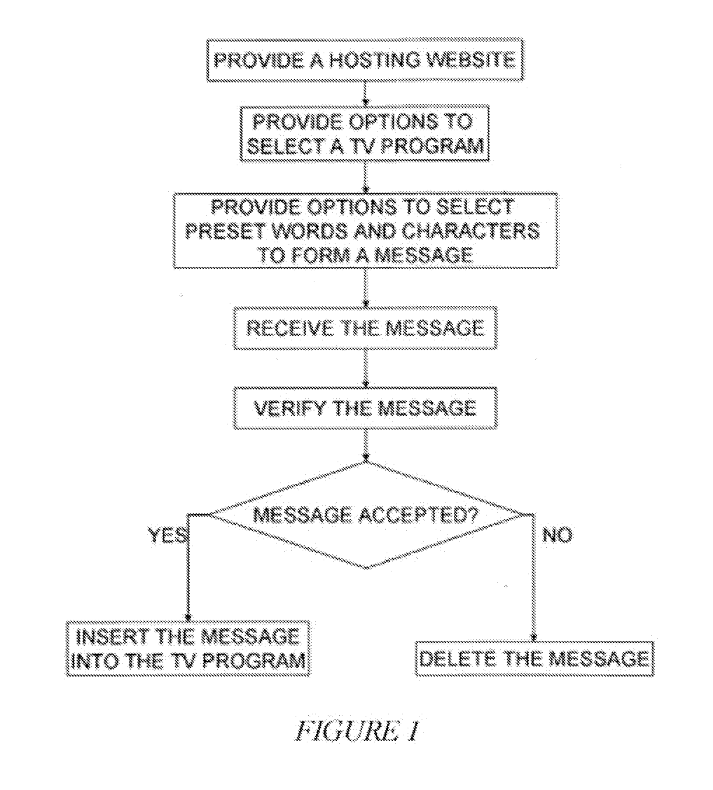

The present invention provides an interaction and voting method for TV audience via the Internet and telephone, The method provides convenient features for members of the TV audience to easily create and transmit messages over the Internet or telephone. p Referring to FIG. 1, the interaction method via the Internet is shown and described. A hosting website is provided for access by members of a television program audience. A member is guided through a plurality of user interfaces (not illustrated). Initially, the member is required to select a program. In accordance with the present invention, the member is not required to type the message. Instead, a plurality of preset words, special characters, and other symbols are provided to a user interface (not illustrated) for the member to select and form a message. Preferably, these preset words, special characters, and other symbols are grouped and can be selected from a plurality of dropdown dialog boxes.

After the message is formed, the member send it to a control station by hitting a send or submit button. The message is received and computationally verified before it is incorporated into the program, which is also selected by the member. In a preferred embodiment, each of the preset words, special characters, and other symbols is assigned with multiple digit codes. The received message is verified by checking these multiple digit codes. Alternatively, a group of preset words, special characters, and other symbols can be assigned with multiple digit codes.

The verification process prevents hacking and filters the message for obscene content. If multiple digit codes match, the message is accepted. The accepted message is then incorporated into the program. The message is rejected and deleted if the multiple digit codes do not match. If a message is accepted, the message is rewritten to the corresponding codes that were received.

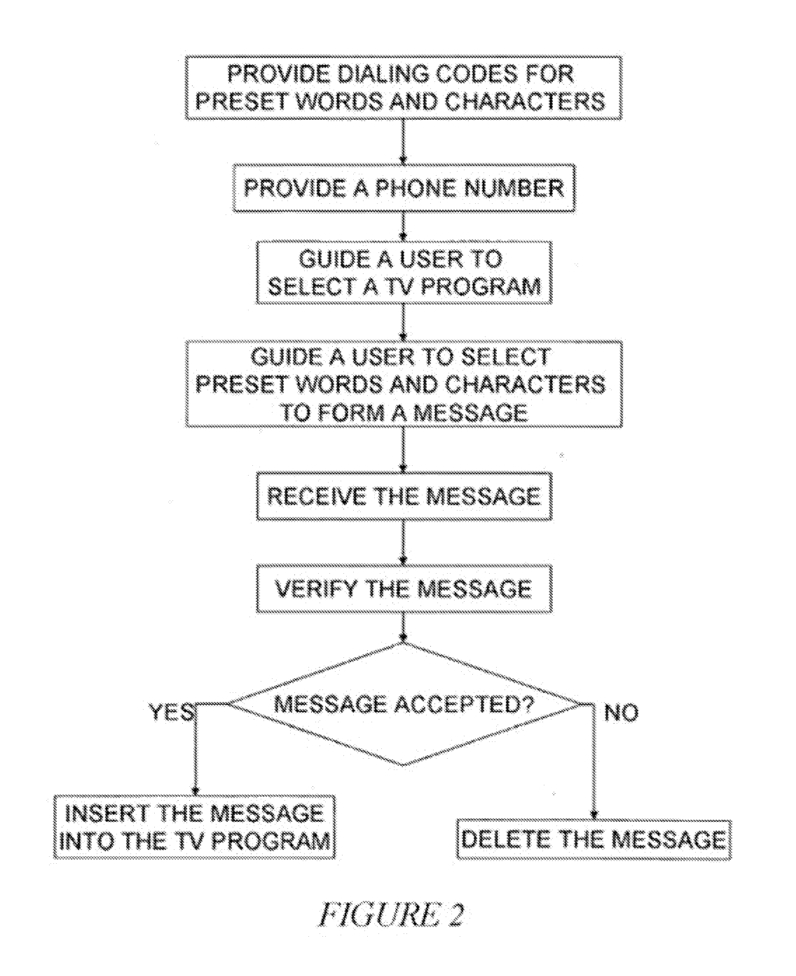

Referring to FIG. 2, the interaction method via telephone is shown and described. A member is guided through a plurality of voice prompts over the phone after dialing a phone number. In accordance with this embodiment, each of the preset words, special characters, and other symbols is assigned a number code. Members are required to dial the number codes via telephone, following voice prompts, to select the program and form the message. Members then send the message, which is received by a control station.

The TV program can also be assigned a number code for selection over the phone. Alternatively, the phone number itself can be dedicated to the TV program. Certain messages are also preset and assigned a number code. The assigned number codes are provided to the member, preferably on a website.

The received message is computationally verified before incorporation into the TV program selected by the member. The verification process explained above using multiple digit codes is also employed in this embodiment. Finally, the accepted message is inserted into the TV program.

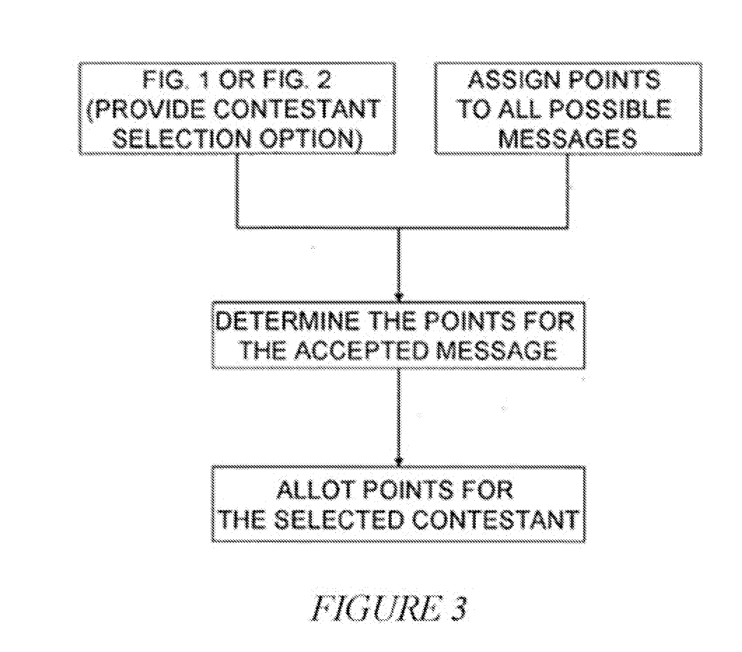

Referring to FIG. 3, the present invention also provides a method of voting. Many live TV shows involve competitions that encourage audience members to vote. The voting method involves selection of a contestant of a TV show and creating a message concerning the performance of the selected contestant. The message can be created by the interaction methods via the Internet or telephone described previously, by including a contestant selection option.

According to the voting method, each message possible by the combination of the preset words is assigned specific number of points. The number of points is determined based on the positive and negative expression or emotion of the message. Once the message is created and accepted, the points assigned to it are allotted to the selected contestant. In this way, a plurality of members can participate in the voting and the points of the messages sent by them are added to determine the total number of votes for the contestant. The contestant with the maximum number of votes is determined as the winner.

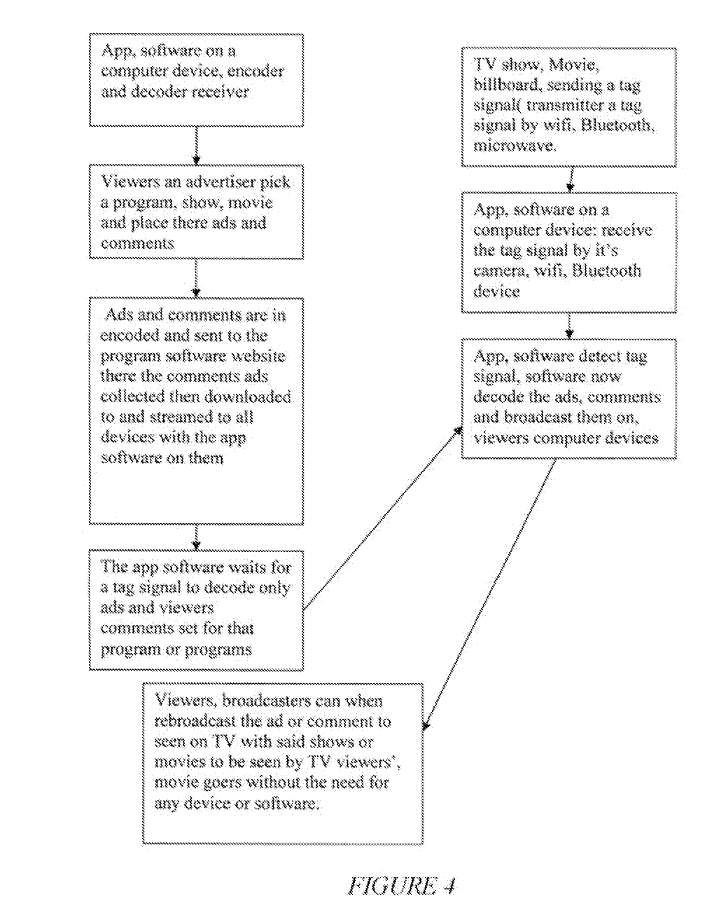

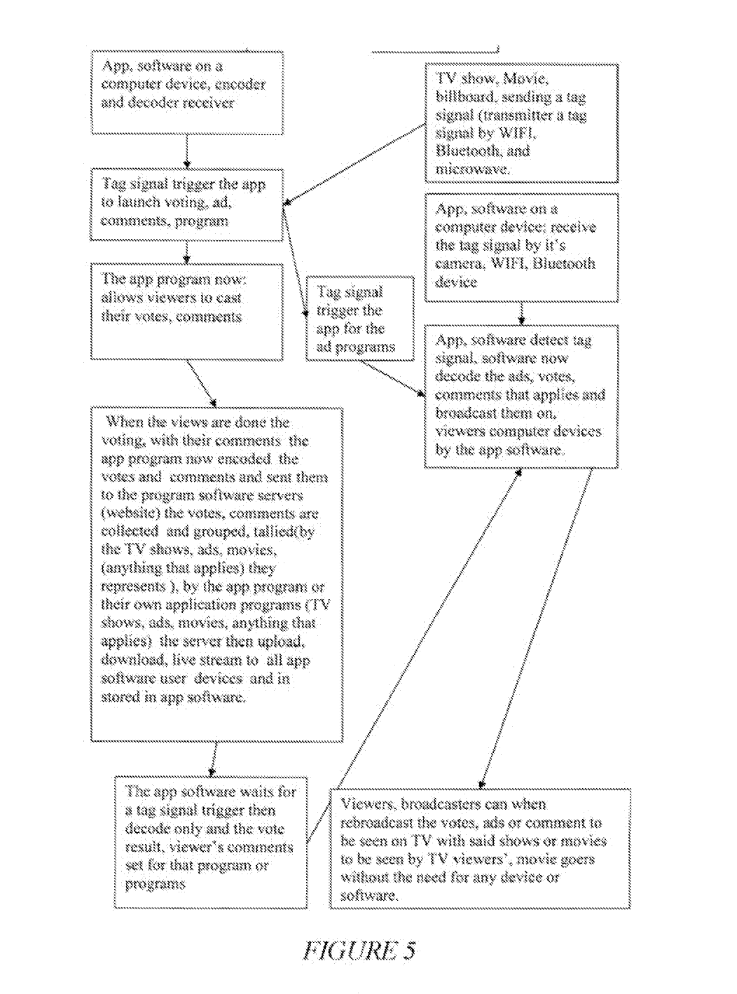

Referring to FIGS. 4 and 5, an alternative embodiment form of comment is described. In this embodiment, a series of waves sent by low sound wave, high sound wave, microwave, Wi-Fi, or Bluetooth to be received by a camera, microphone, Wi-Fi, or Bluetooth is contemplated. These a series waves forms comprise tag patterns which are embedded in any form of audio or video format, including in all or only some part of the audio and video format.

In this embodiment the app program is turn on and will receive an encoded signal from a video or audio source. A link to the video source is activated and allows the viewer using the app program to send their text, video clip to hook on, tag by embedding back into body the video (without touching the source). These viewer comments are a form of audio hook, video hook, text hook, and can be viewed in the same app program (the app program utilizing for example a camera from a phone, tablet and/or computer. When viewing or hearing a visual or audio program the viewer can the take the camera from the device to view the visual or audio program.

Information such a voice, text and video, comments by other users or by the program, can now be seen by the camera overlay. If there is no camera available, the same app program may be used to view the same comments and as the camera overlay and more. A video hook signal is used to broadcast information about a video movie (program) or comments by viewers, owner, or advertising personnel. The program can be an app or embedded in a web site, may be incorporated into a stand-alone box or in a computer chip to be place in any device to perform the same or similar tasks. A TV station, movie owner may simply use a camera overlay program box and re-air the comments of viewers during same time the, audio or video program is aired, and place these comments any where on the screen. Similarly, a website owner may do the same.

Referring to FIG. 4, a flowchart for the first alternative embodiment is shown in detail. App software on a computer device, an encoder and decoder receivers is provided. Viewers and advertisers select a program, for instance a television show or movie, and place advertisements and comments. The ads and comments are encoded by the device and sent to the program software website where they are collected, downloaded and streamed to all devices containing the app software. The app software waits for a tag signal to decode only ads and viewers comments set for a particular program or programs. In the meantime, a television show, movie, billboard, or similar programming sends a tag signal, transmitting the signal by Wi-Fi, Bluetooth, microwave or similar transmission method. The app software on the computer device receives the tag signal by its camera, Wi-Fi, Bluetooth or similar transmission method, and the app software detects the tag signal, decodes the ads and comments and broadcasts them on viewers' computer devices. Viewers and broadcasters can broadcast the ad or comments to be seen along with a program such as a TV program or movie without the need for any additional devices or software.

Referring to FIG. 3, a second alternative embodiment is described in detail. As with the first alternative embodiment an app or software on a computer device is provided including an encoder and decoder receiver. A program such as a TV show, movie, billboard or similar sends a tag signal transmitting the tag signal by Wi-Fi, Bluetooth, microwave or similar transmission means. The tag signal triggers the app to launch voting, ad, comments in the program and the app program allows viewers to cast their votes or make comments, etc. At the same time, the tag signal triggers the app for the ad programs. An app, software on a computer device receives the tag signal by its camera, Wi-Fi, Bluetooth or similar device, and with the signal trigger, decodes the ads votes, or comments, etc. that apply and broadcasts them on viewer's devices using the app software.

When viewers are finished voting with their comments the app program software encodes the votes and comments and sends them to the program's website software servers where the votes, comments, etc. are talked by the program (i.e., TV show, ad, movie, etc.) The server then uploads or downloads a live stream to all app software user devices in which the app is stored. The app software then waits for a tag signal trigger then decodes only the vote results and the viewer's comments for a particular program. Once again, the app software detects a tag signal and the software decides the ads, votes and comments and broadcasts them on viewer's computer devices using the app software. Viewers and broadcasters can, when rebroadcasting the votes, ads or comments, show them on a TV with shows or movies without the need for any device or software.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for audience interaction and voting, including a member providing audience feedback, comprising the steps of:
a first viewer of a program identifying a member of the program;
launching software on a computerized device having a memory an encoder and a decoder;
providing a tag signal to trigger the software thereby providing a plurality of preset words, special characters and other symbols for the member to select via the Internet in order to form a message concerning the performance of the contestant;
encoding the plurality including all possible combinations of the plurality;
the program receiving the plurality via the Internet;
the program verifying the received message to prevent hacking and filter content;
the program waiting for the tag signal and upon receiving the tag signal, decoding the plurality;
inserting the plurality into the program upon selection by a second user; and
allotting the points to the plurality.

2. The method of claim 1, wherein the member logs onto a hosting website, selects the program and composes the message received via the Internet for inserting into the program.

3. The method of claim 2, wherein a plurality of drop down dialog boxes are provided for selecting the preset words, special characters, and other symbols.

4. The method of claim 1, wherein each of the preset words, special characters and other symbols is assigned a number code, and a member, guided through a voice prompt series via telephone, dials the number codes to form the message.

5. The method of claim 4, wherein at least one of the messages is preset and assigned a number code to expedite selection.

6. The method of claim 1, wherein each of the preset symbol is assigned multiple digit codes, the message being verified by analyzing the multiple digit code.

7. The method of claim 10, wherein a group of the preset words, special characters and other symbols can also be assigned with multiple digit codes.

8. The method of claim 1, wherein the method is used for voting in a live TV program.

9. The method of claim 12, wherein all possible messages are assigned specific points and voting comprises a member selecting a program contestant via the Internet, forming the message concerning the performance of the contestant, and allotting the points of the message to the contestant.

10. The method of claim 13, wherein a plurality of members participate in voting, and the points of the messages allocated by the members are added to determine the total number of votes for a contestant.

11. The method of claim 1, wherein the name of the member is inserted corresponding to the message.

12. The method of claim 1, wherein a hosting website is provided for the member to log on, select the TV program, the contestant, and the preset words, special characters, and other symbols.

13. The method of claim 1, wherein the member is guided through a series of voice prompts in order to select the program and a contestant, and each preset symbol or symbols is assigned a number code for the member to enter following the voice prompts to form the message, the assigned number codes being provided to the member.

14. The method of claim 4, wherein some of the messages are preset and assigned the number code to expedite the member's selections.

15. The method of claim 1, wherein each of the preset words, special characters and other symbols is assigned multiple digit codes, the message being verified by analyzing the multiple digit codes.

16. The method of claim 1 including embedding a tag signal in audio or video, or a poster emitting a tag signal in any form.
